(19) United States
(12) Patent Application Publication
(10) Pub. No.: US 2008/0005084 A1
(43) Pub. Date: Jan. 3, 2008

(54) Method for Determining Validity of Command and System Thereof

(75) Inventors: Jung Soo Ha, Seoul (KR); Jung Su Kim, Seoul (KR); Woo Sung Lee, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/570,253

(22) PCT Filed: Jun. 8, 2005
(86) PCT No.: PCT/KR05/01710

§ 371 Date: Dec. 8, 2006

(30) Foreign Application Priority Data
Jun. 8, 2004 (KR) 10-2004-0041620

(51) Int. Cl. G06F 17/30

(52) U.S. Cl. 707/3; 707/1; 707/E17.001

(57) ABSTRACT

Disclosed is a method for determining the validity of a command line, the method including the steps of: maintaining a permit database including information on a permitted network address and at least one blocked keyword associated with the permitted network address; receiving a command line including a request content from a terminal of a user; extracting network address information or the request content included in the command line; determining whether the extracted network address information is permitted network address information by referring to the permit database; determining whether the request content has relation with the at least one blocked keyword associated with the permitted network address information by referring to the permit database, in case that it is determined that the extracted network address information is permitted network address information; and performing validity determination with respect to the command line in accordance with a predetermined determination method, in case that it is determined that the extracted request content has relation with the blocked keyword.

### TECHNICAL FIELD

The present invention relates to a method for determining the validity of a command line inputted from a terminal of a user. More particularly, the present invention relates to a method for determining the validity of a command line in which a command line satisfying a predetermined rule is determined to be valid or invalid among command lines inputted from a user and the validity determination process is performed with respect to a command line unsatisfying the rule in accordance with a predetermined determination method.

### BACKGROUND ART

In a server/client model, a client accesses a server via a network and inputs a predetermined request, and the server responds the request to a terminal of a user.

The user may input the request in order not to obtain the response but another purpose.

For example, a search server providing search service may statistically analyze and use the search request of the user in order to generate a search result list according to preference of the user. Since a search result “frequently” selected by a user receiving a predetermined search result list whose relation with a search request is high and the preference of users is considered to be high, the search server distributes priority to the search result in order to preferentially provide the search result to users.

In this case, “search result selection” of the user is used as “a request for receiving information associated with the search result or accessing a webpage associated with the search result” or “a standard for generating a search result list”. A user knowing the fact described above may repeatedly select an identical search result from a search result list provided by responding to a predetermined search query, thereby distributing the priority of a search result selected by the user. Of course, in case that the priority is distributed by repeatedly selecting the search result by the user, an original object that tries to preferentially provide a search result whose relation with the search result is high and preferred by users cannot be obtained.

Accordingly, in case that a user inputs a request for selecting a search result, it is necessary to determine whether the request is inputted with malicious intent. In case that the request is determined to be inputted with malicious intent, information associated with the search result is provided according to the request but is not preferable to be used as a standard for generating a search result list. As described above, it may be necessary to determine whether “a request” of a user, inputted to a predetermined system, is generated with malicious intent, which is against the object of the system.

Hereinafter, “command” used in the present specification indicates an inclusive concept including “a request” of a user, for performing a predetermined operation in a predetermined server system, “a conversation” or “information” of a user, for providing predetermined information to the server system. “The command” may be transmitted from a terminal of the user to the server system by transmitting “a command line” to the server system.

Korean Patent Application No. 10-2002-7010554 (“Title: A system and method to determine the validity of an interaction on a network, hereinafter, referred to as “application invention”) discloses one of methods of determining the validity of a command line of a user. The Korean Patent Application designates a conversation inputted with malicious intent of a user as “an illegal conversation” in the specification.

The application invention includes 1) a step of collecting data including “collective method data” and “private characteristic data” from a user conversation on network, 2) a step of storing data in a database, 3) a step of building an estimation model by collective method and private characteristic data in order to identifying an illegal conversation with a network, and 4) a step of identifying an illegal conversation in the database by using the estimation model.

Also, the application invention discloses ‘the number of a private user ID per search list click/unit time’, ‘the number of a private user ID per entry source/unit time’, and ‘the number of a private user ID per advertiser/unit time, which accepts a click capable of any application’.

Also, the application invention discloses ‘a date of a click generating an income’ and ‘a time stamp of a click generating an income’ as “private characteristic data”.

However, the application invention determines whether a conversation is valid by using the estimation model whenever a conversation is inputted. That is, “acceptable but uncommon class (ABUC) value’, “normal behavior class (NBC) value”, and “unacceptable class value” are respectively computed [symbol] with respect to one conversation [symbol] and determine the conversation to be included in the class whose value is largest among them.

Accordingly, in case that the conversation is easily to be determined to be invalid by considering the pattern of the conversation or analyzing information collected so far, an identical system resource is used for respectively computing and comparing the ABUC value, the NBC value, and the UC value and the conversation is determined to be invalid, thereby unnecessarily consuming the system resource.

### DISCLOSURE OF INVENTION

Technical Goals

The present invention provides method and system for determining the validity of a command line, which can simply determine the validity of a command line inputted from a user in accordance with a predetermined rule and perform an additional validity determination by a selected determination method only in case that it is impossible to determine the validity of the command line in accordance with the rule. That is, the present invention provides method and system for determining the validity of a command line, which can determine a command line corresponding to or not corresponding to information stored in a permit database or a block database to be valid or invalid in accordance with a predetermined rule and thus, omit an additional validity determination procedure.

Also, the present invention provides method and system for determining the validity of a command line, which divides a command line validity determination process into two parts, a first process of determining whether a command line corresponds to a predetermined rule and a second process of determining the validity of a command line not corresponding to the rule in accordance with a predetermined determination method, and can reduce load of a system performing a command line validity determination and enhance the speed thereof by terminating a command line validity determination process by using the first process only, with respect to a command line of which validity can be determined simply and fast.

Also, the present invention provides method and system for determining the validity of a command line, which determines a command line inputted from a network address or a network group that is reliable and well-known, such as a command line inputted from a network address of a terminal of a manager or a developer, and a command line inputted from a network address of a terminal of government and public offices or a large company, to be valid, thereby omitting an additional validity determination process.

In the meantime, the present invention provides method and system for determining the validity of a command line, which can more accurately determine the validity of a command line by not omitting a validity determination process with respect to a command line including a request content has the least possibility to be inputted from public and government offices, although the command line is inputted from the public and government offices and the large company.

Technical Solution

In order to achieve the above goals and solve the problems in the prior art, according to the present invention, there is provided a method for determining the validity of a command line, including the steps of: maintaining a permit database including information on a permit network address and at least one block keyword associated with the permit network address; receiving a command line including a request content from a terminal of a user; extracting network address information or the request content included in the command line; determining whether the extracted network address information is permit network address information by referring to the permit database; determining whether the request content has relation with the at least one block keyword associated with the permit network address information by referring to the permit database, in case that it is determined that the extracted network address information is permit network address information; and performing validity determination with respect to the command line in accordance with a predetermined determination method, in case that it is determined that the extracted request content has relation with the block keyword.

Also, according to an aspect of the present invention, the determination method further includes the step of determining the command line to be valid in case that it is determined that the extracted request content has no relation with the block keyword.

**Explanation of Terms Used in the Present Specification**

1) Network Address Information

A network address used in the present specification includes an IP address and is used for identifying a location of a terminal on a network. Information on the network address is defined as “network address information”.

2) Database

A permit database, a block database, or a log database used in the present specification is a kind of databases. The “database” is a group of data which is systematically recorded in a recording device, such that relation among data can be easily grasped.

3) First Determination System and Second Determination System

A determination system according to the present invention includes a first determination system and a second determination system. It is divided based on the functions thereof. The first and the second determination systems may be embodied by the same device. “The first determination system” in the present specification determines a command line satisfying a predetermined simple rule to be valid or invalid. The command line unsatisfying the rule cannot be determined to be valid or invalid. Thus, the second determination system performs more sophisticated validity determination with respect to the command line unsatisfying the rule by using a predetermined determination method.

That is, in “the second determination system”, a command line which is a target for the validity determination is only a command line “filtered” by the first determination system.

4) Predetermined Determination Method

Term “predetermined determination method” used in the present specification is a determination method which is used for determining the validity of a command line in the second determination system.

### BRIEF DESCRIPTION OF DRAWINGS

FIG. 1 is a view illustrating a network connection of a determination system performing a command line validity determination method according to the present invention;

FIG. 2 is a flowchart illustrating a method for determining the validity of a command line according to an embodiment of the present invention;

FIG. 3 is a view illustrating one example of a permit database in an embodiment of the present invention;

FIG. 4 is an example of a search result list provided to a user by a predetermined search system, in an embodiment of the present invention;

FIG. 5 is a flowchart illustrating a method for determining the validity of a command line according to another embodiment of the present invention;

FIG. 6 is a flowchart illustrating procedures of determining the validity of a command line according to a predetermined determination method, in another embodiment of the present invention;

FIG. 7 is a view illustrating one example of log information recorded in a log database, in another embodiment of the present invention;

FIG. 8 is a block diagram illustrating a determination system according to another embodiment of the present invention; and

FIG. 9 is an internal block diagram of a general-purpose computer which can be adopted in implementing the command line validity determination method according to the present invention.

### BEST MODE FOR CARRYING OUT THE INVENTION

Hereinafter, the present invention will be in detail described with reference to the accompanying drawings.

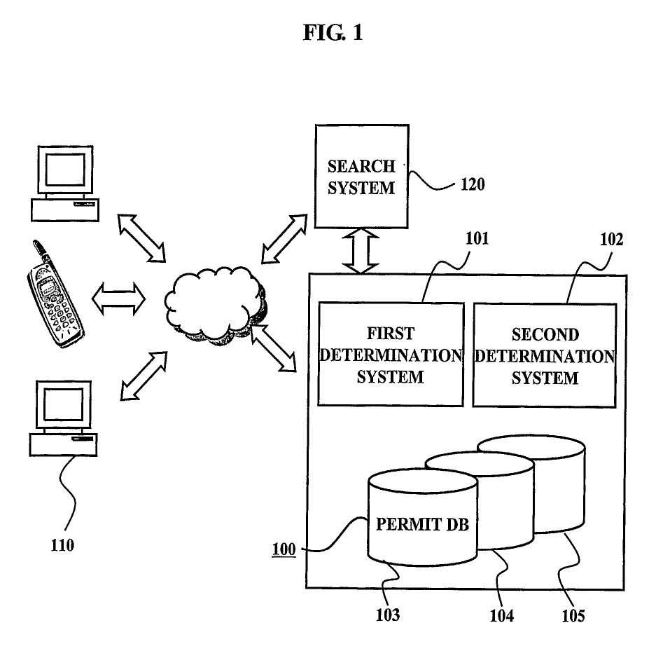

FIG. 1 is a view illustrating a network connection of a determination system performing a command line validity determination method according to the present invention. A determination system 100 includes a first determination system 101, a second determination system 102, a permit database 103, a block database 104, and a log database 105. The determination system 100 can be connected to a user terminal 110 of a user or the like through a wired/wireless communication network. The determination system 100 can process a command line inputted from the user and give a response thereto to the user.

Also, hereinafter, it will be described that the determination system 100 interoperates with a search system 120 and determines the validity of a command line inputted from the terminal of the user using a search system 120. At this time, the search system 120 is only an illustrative example. The scope of the present invention reaches all the service systems receiving command lines from users and in response thereto, providing a predetermined service, such as for example, a game service, a booking service, a knowledge providing service, and the like, to the users. Also, the determination system 100 and the search system 120 may be embodied in the same device. It is also included in the scope of the present invention.

Also, hereinafter, it will be described that an IP address is used as a network address.

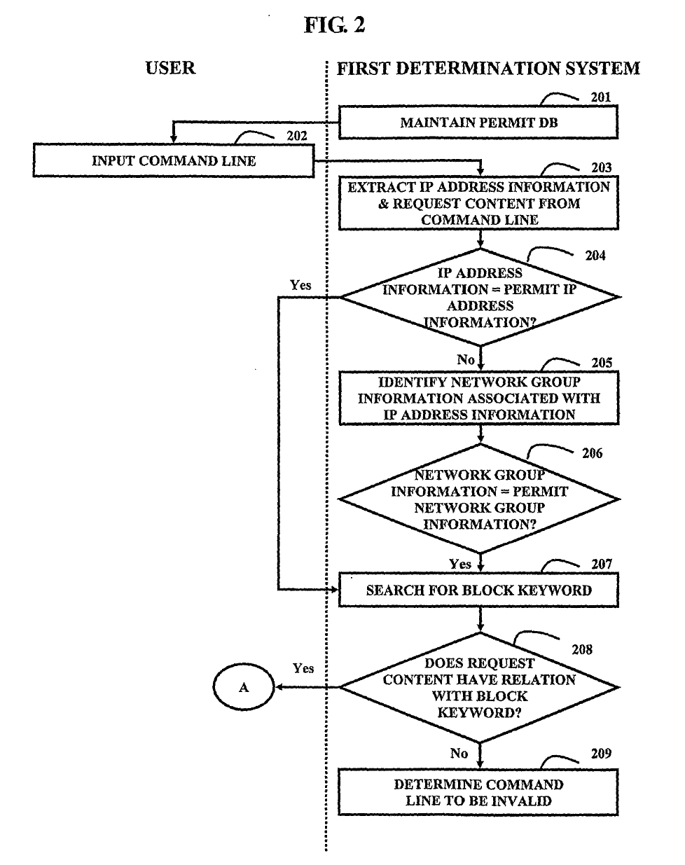

FIG. 2 is a flowchart illustrating a method for determining the validity of a command line according to an embodiment of the present invention. In step 201, the first determination system 101 maintains the permit database 103.

According to an embodiment of the present invention, the permit database 103 includes permit IP address information or permit network group information. The permit IP address information may be IP address information of government and public offices, IP address information of domestic large companies, and the like, which is well known IP address information and has the least possibility to input an illegal command line.

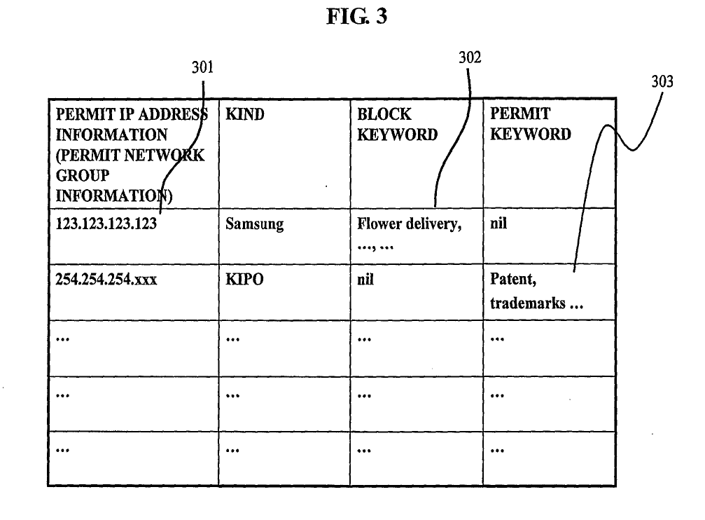

FIG. 3 is a view illustrating one example of the permit database 103. In FIG. 3, a drawing symbol 301 indicates IP address information associated with “Samsung” which is a reliable domestic company. A drawing symbol 302 indicates block keyword “flower delivery” associated with “Samsung”.

In step 202, the search system 120 receives a command line from the terminal 110 of a user. In step 203, the first determination system 101 extracts IP address information included in the command line.

In step 204, the first determination system 101 determines whether the extracted IP address information is permit IP address information by referring to the permit database 103. For example, in case that the extracted IP address information is “254.254.254.254”, it can be known that the IP address information extracted from the permit database 103 is permit IP address information.

Also, in step 205, the first determination system 101 identifies network group information about a network group associated with the IP address by using the IP address information.

For example of the network group, there is a network class according to IPv4. The network class is with respect to the mechanism of dividing an IP address space. In an IP address system according to the IPv4 formed of four octets having 8 bit, a network accessed by a terminal having an IP address may be identified from the IP address information. For example, a class C network has IP addresses from 192.0.0.0 to 223.255.255.0, and three octets from the front are used for indicating a network number.

Accordingly, the first determination system 101 can identify a network group associated with the IP address from IP address information. Also, in the above embodiment, the IPv4 has been described as an illustrative example. However, it is apparent that the present invention may be applied to an IP address method of adopting a method dividing an IP address space into at least one group.

In step 206, the first determination system 101 determines whether the identified network group information is permit network group information by referring to the permit database 103. For example, in case that extracted IP address information is “254.254.254.254”, the identified network group information is “254.254.254.xxx”. A random number between 0 and 255 can be inputted in “xxx”. Referring to FIG. 3, the network group information “254.254.254.xxx” identified from the permit database 103 is permit network group information.

Also, according to another embodiment of the present invention, the first determination system 101 may perform steps 205 and 206, only in case that it is determined that the extracted IP address information is not permit IP address information in step 204.

In case that it is determined that the extracted IP address information is permit IP address information in step 204, or in case that it is determined that the identified network group information is permit network group information, the first determination system 101 determines the command line to be valid in step 209.

The second determination system 102 does not perform validity determination according to the predetermined determination method, with respect to a command line determined to be valid by the first determination system 101 like above. That is, the first determination system 101 records IP address information about government and public offices, large companies, and the like, which have the least possibility to input an illegal and vicious command line, i.e., reliable, in the permit database 103. The first determination system 101 can simply determine the validity of a command line by using the recorded IP address information.

Accordingly, a command line satisfying a predetermined rule is simply determined to be valid in the first determination system 101. At this time, complicated determination procedures in the second determination system 102 are omitted. It will be described later. Thus, since the entire computation capacity or the data capacity to be recorded in the determination system 100 decreases, the load of the determination system 100 can be reduced.

Also, according to another embodiment of the present invention, the permit database 103 further records at least one block keyword associated with permit IP address information or permit network group. For example, as illustrated in FIG. 3, the block keyword associated with permit IP address information “123.123.123.123” is block keyword “flower delivery”.

In the present embodiment, the first determination system 101 can filter a command line more accurately by using not only permit IP address information or permit network address information, but also a block keyword. That is, while a command line is inputted from a terminal having a reliable IP address, the first determination system 101 may further determine whether the command line is valid or invalid by using the block keyword.

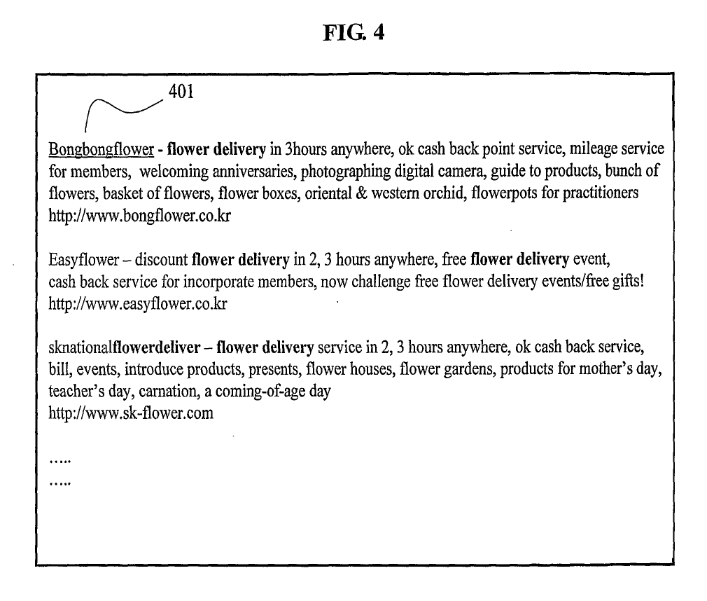

In step 203, the first determination system 101 further extracts IP address information and a request content from the command line. For example, when a user inputs keyword “flower deliver” in the search system 120, in response thereto, the search system 120 provides the user with a search result list as illustrated in FIG. 4. The user inputs a command line to select a search result, for example, a search result 401, from the search result list. The command line may be generated in such a manner that the user clicks search results displayed on a web browser of his/her own user terminal 110 using a mouse.

In the present embodiment, as an example, it will be described that the command line inputted in step 202 is a command line generated by clicking the search result 401. That is, a request content included in the command line relates to selecting the search result 401, and more particularly, may be a request for link to a web page associated with the search result 401.

In case that the extracted IP address information is permit IP address information, the first determination system 101 searches for a block keyword associated with the permit IP address information by referring to the permit database 103, in step 207. Or, in case that identified network group information is permit network group information, the first determination system 101 searches for a block keyword associated with the permit network group information by referring to the permit database 103, in step 207. For example, in case that the extracted IP address information is “123.123.123.123”, it can be known that the extracted IP address information is permit IP address information and the block keyword associated with the permit IP address information is “flower deliver”.

Like above, in case that at least one block keyword is search as a result of search, the first determination system 101 determines whether the request content has relation with the block keyword in step 208. For example, the first determination system 101 may determine that the request content has relation with the block keyword, in case that the block keyword and the request content correspond to a predetermined rule. The rule may be properly selected and stored by an operator of the determination system 100 according to embodiments.

The block keyword searched in step 207 is “flower deliver”. The request content extracted in step 203 is for selecting one search result from the search result list provided in response to a search request for “flower deliver”. Thus, the first determination system 101 may determine that the request content has relation with the block keyword “flower deliver”.

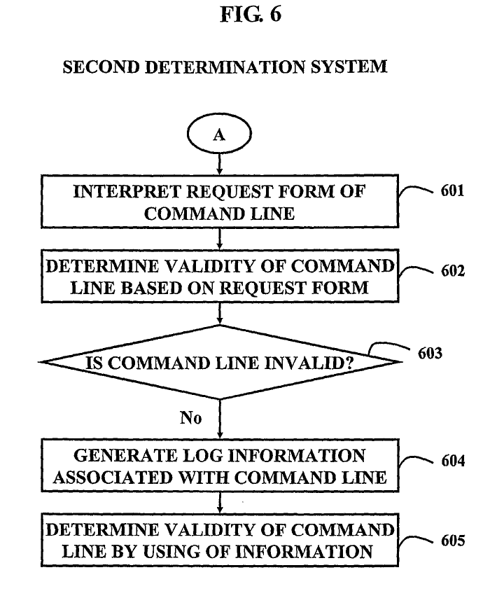

In case that the request content has relation with the block keyword like above, that is, in case that the command line is inputted from a reliable IP address or an IP address included in a reliable network group, and in case that the request content included in the command line has relation with the block keyword, the first determination system 101 does not determine the command line to be valid immediately. The first determination system 101 enables the second determination system 102 to perform additional validity determination with respect to the command line in accordance with the predetermined determination method and determine the validity of the command line more accurately. Procedures of determining the validity in the second determination system 102 will be described later with reference to FIG. 6.

Meanwhile, in case that a block keyword associated with the permit IP address information or the permit network group information is not searched in step 207, or in case that at least one block keyword is searched in step 207, however, it is determined that the searched block keyword has no relation with the request content, for example, in case that the request content is for requesting a keyword search with respect to keyword marketing” and the searched block keyword is “flower delivery”, the first determination system 101 determines the command line to be valid in step 209 and the second determination system 102 performs validity determination with respect to the command line.

That is, the first determination system 101 filters a command line which can be determined to be valid simply by using IP address information and a request content included in the command line and data recorded in the permit database 103. Also, the first determination system 101 enables a more accurate validity determination to be performed in the second determination system 102 with respect to a command line which cannot be determined to be valid simply by using IP address information and a request content included in the command line and data recorded in the permit database 103.

Also, according to another embodiment of the present invention, instead of a block keyword, a permit keyword may be recorded in the permit database 103 in association with permit network group information or permit IP address information.

In case that IP address information included in a predetermined command line is permit IP address information, the first determination system 101 searches the permit database 103 for a permit keyword associated with the permit IP address information. In case that a request content included in the command line has relation with the permit keyword, the first determination system 101 determines the command to be valid. In case that the request content has no relation with the permit keyword, the first determination system 101 cannot determine the validity of the command line. Thus, the first determination system 101 enables validity determination with respect to the command line to be performed in the second determination system 102.

Also, as illustrated in FIG. 3, a block keyword may be recorded in the permit database 103 in association with one permit IP address information or permit network group information, or a permit keyword recorded in the permit database 103 in association with another permit IP address information or permit network group information. For example, the block keyword may be recorded in the permit database 103 in association with first permit IP address information. The permit keyword may be recorded in the permit database 103 in association with second permit IP address information.

At this time, in case of a command line inputted from the first permit IP address information, the first determination system 101 determines the command line to be valid in case that a request content included in the command line has no relation with the block keyword. Also, in case of a command line inputted from the second permit IP address information, the first determination system 101 determines the command line to be valid in case that a request content included in the command line has relation with the permit keyword. In the opposite case to the above, additional validity determination is performed in the second determination system 102 with respect to a corresponding command line.

Hereinafter, a command line validity determination method according to another embodiment of the present invention will be described. In the present embodiment, the first determination system 101 determines a command line associated with a predetermined permit keyword to be valid. The first determination system 101 enables additional validity determination not to be performed in the second determination system 102 with respect to the command line.

An operator of the first determination system 101 records a keyword associated with a target for interests of users in the permit database 103 as a permit keyword. The keyword is a keyword associated with a social issue, or a keyword associated with a gift or an event, or the like.

The first determination system 101 extracts a request content included in a command line inputted from a user. Also, the first determination system 101 determines whether the request content has relation with the permit keyword. In case that it is determined that the request content has relation with the permit keyword, the first determination system 101 determines the command line to be valid or invalid.

On the contrary, in case that it is determined that the request content has no relation with the permit keyword, the first determination system 101 enables validity determination with respect to the command line to be performed in the second determination system 102.

According to the present embodiment, as aforementioned, by setting up a keyword associated with a subject with growing interests of users as a permit keyword, it is possible to prevent the command line inputted by a large number of users abnormally more than usual from being mistaken for a command line inputted with an illegal and ill intention by the second determination system 102.

Also, according to another embodiment of the present invention, the first determination system 101 computes the input number of a command line associated with a predetermined permit keyword for each period. The first determination system 101 updates the permit database 103 by using the input number for each period. For example, in case that the input number for each period drops down under a predetermined value, it is possible to determine that interests of users about a target associated with the permit keyword have decreased. Depending on the determination, the keyword used as a permit keyword so far may not be maintained as the permit keyword any more. That is, the permit keyword is deleted from the permit database 103.

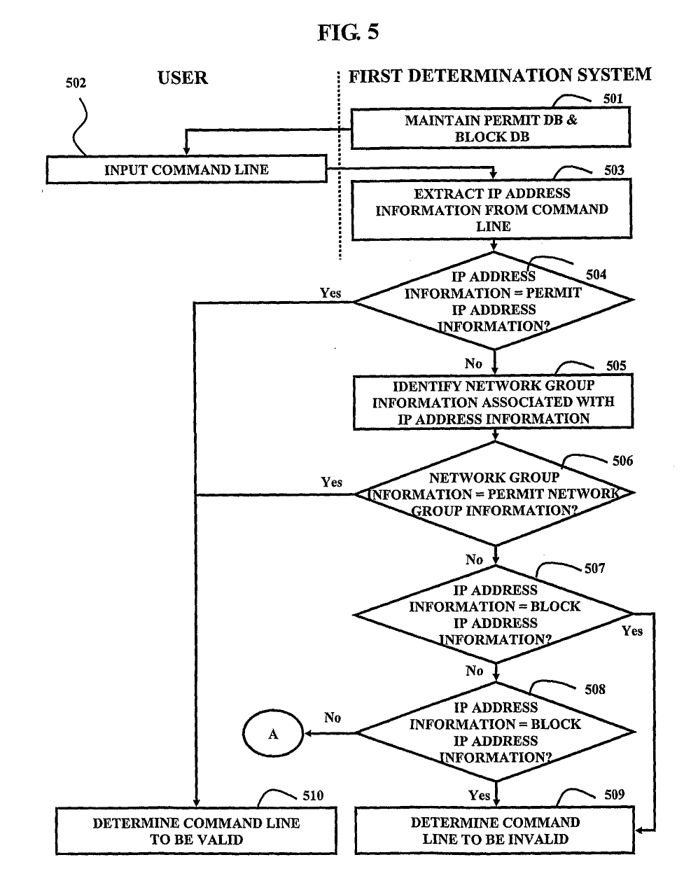

Hereinafter, a command line validity determination method according to another embodiment of the present invention will be described with reference to FIG. 5. In the present embodiment, permit IP address information and permit network group information is recorded in the permit database 103. Block IP address information and block network group information is recorded in the block database 104. The permit database 103 and the block database 104 may be embodied in the same device.

Permit IP address information or permit network group information recorded in the permit database 103 relates to an IP address of a terminal which is regarded to input a normal command line, or to a network group including the IP address.

Block IP address information or block network group information recorded in the block database 104 relates to a predetermined IP address or a predetermined network group, in case that it is preferable to determine a command line inputted from the IP address or the network group to be valid. For example, the first determination system 101 can select IP address information (or network group information) about an IP address (or a network group including the IP address) of a terminal having the highest possibility to input a command line with an illegal/ill intention which does not correspond to a service provided at the search system 120, as block IP address information (or network group information). In many cases, command lines inputted from the terminal such above are invalid. Thus, the command lines are determined to be invalid without going through complicated command line determination procedures in the second determination system 102. Because of this, load of the determination system 100 is reduced. Also, in case that a user of the terminal intends to input an illegal command line having a different pattern from ones so far by using a new method, for example, by using a new method of an illegal command line automatic input program, it is fundamentally prevented.

Also, according to another embodiment of the present invention, the first determination system 101 can determine IP address information about an IP address of a terminal of a developer or an operator of the determination system 100 as block IP address information. The developer and the like does not input a command line in the search system 120 for the original purpose estimated by the determination system 100, such as a search, a selection of search result, and the like. In many cases, the developer and the like input a command line in order to test that the determination system 100 operates properly. Thus, it is not preferable to determine the command line inputted from the developer to be valid and, based on the valid command line, to charge a predetermined advertising cost to an advertiser who has requested advertising at the search system 120. The first determination system 101 prevents such a problem by determining IP address information or network group information with respect to a terminal of the developer as block IP address information or block network group information.

Also, in case that the search system 120 provides an advertising service in association with a search, an IP address of a terminal of an advertiser using the advertising service or a network group including the IP address may be also determined as a block IP address or a block network group. Also, in many cases, the advertiser inputs a command line in order to check whether advertising goes well at the search system 120, rather than for the original purpose, such as, a search, a selection of a search result, and the like.

In step 502, the first determination system 101 receives a command line from the terminal 110 of a user. In step 503, the first determination system 101 extracts IP address information included in the command line.

In step 504, the first determination system 101 determines whether the extracted IP address information is permit IP address information by referring to the permit database 103.

Also, in step 505, the first determination system 101 identifies network group information about a network group associated with the IP address by using the same. In step 506, the first determination system 101 determines whether the identified network group information is permit network group information by referring to the permit database 103. In the meantime, according to another embodiment of the present invention, the first determination system 101 may perform steps 505 and 506 only in case that it is determined that the extracted IP address information is not permit IP address information in step 504.

In case that it is determined that the extracted IP address information is permit IP address information in step 504, or in case that it is determined that the identified network group information is permit network group information in step 506, the first determination system 101 determines the command line to be valid in step 510. In this case, the second determination system 102 does not perform validity determination with respect to the command line.

In case that it is determined that the extracted IP address information is not permit IP address information, or in case that it is determined that the identified network group information is not permit network group information, the first determination system 101 determines whether the extracted IP address information is block IP address information by referring to the block database 104 in step 507.

Also, in step 508, the first determination system 101 determines whether the identified network group information is block network group information by referring to the block database 104. Meanwhile, according to another embodiment of the present invention, the first determination system 101 may perform step 508 only in case that it is determined that the extracted IP address information is not permit IP address information in step 507.

In case that it is determined that the extracted IP address information is block IP address information, or in case that the identified network group information is block network group information, the first determination system 101 determines the command line to be invalid in step 509. In this case, the second determination system 102 does not perform validity determination with respect to the command line.

According to the present embodiment, in case of the command line of which the validity is not determined at the first determination system 101, the validity thereof is determined at the second determination system 102. That is, the first determination system 101 determines a command line satisfying a predetermined rule to be valid or invalid simply. The first determination system 101 enables additional validity determination to be performed only with respect to the command line which is not determined to be valid or invalid. Thus, the system load at the determination system 100 is reduced.

Hereinafter, the process that the second determination system 102 determines the validity of a command line filtered by the first determination system 101 in accordance with a predetermined determination method will be in detail described with reference to FIG. 6.

In step 601, the second determination system 102 interprets a request form of the inputted command line. In step 602, the second determination system 102 determines the validity of the command line on the basis of the request form.

According to another embodiment of the present invention, in case that the command line is determined to be invalid based on the request form, determination procedures after step 603 may not be performed with respect to the command line.

In step 603, the second determination system 102 generates log information associated with the command line. The log information may include the extracted IP address information, input time point information about the time point when the command line is inputted into the search system 120, a request content included in the command, and the like.

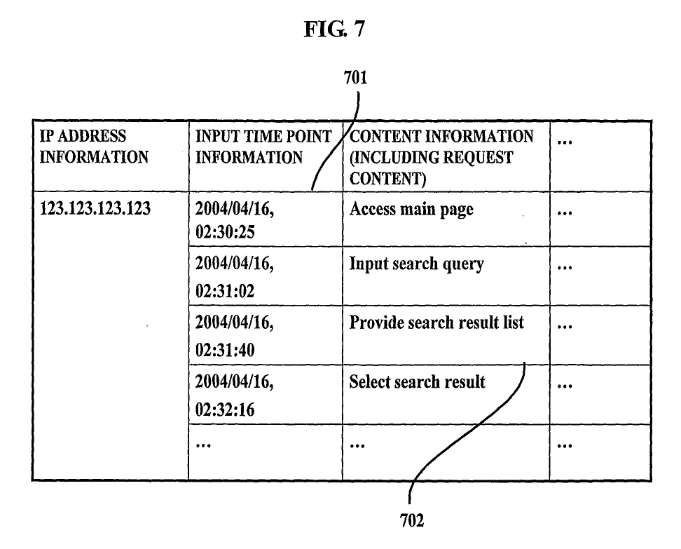

In step 604, the second determination system 102 records the log information in the log database 105. FIG. 7 is a view illustrating an example of log information recorded in the log database 105. As illustrated in FIG. 7, according to another embodiment of the present invention, the log information may be sorted in accordance with the input time point of the command line, or systematically recorded in association with the IP address information. Also, log information corresponding to a command line inputted from a user may be recorded in the log database 105. Log information 701 associated with the access in case that the user accesses the search system 120, and log information associated with information provided to the user by the search system 120, for example, log information 702 associated with a search result list provided to the user, also may be recorded in the log database 105.

In step 605, the second determination system 102 determines the validity of the command line by using the log information. The second determination system 102 may use only log information generated in association with the command line. Also, the second determination system 102 may determine the validity of the command by further using at least one piece of log information recorded in the log database 105.

Hereinafter, the step 602 of determining the validity of a command line based on the request form and the step 605 of determining the validity of a command line by using log information according to embodiments will be in detail described.

1. A Procedure of Determining the Validity of the Command Line Based on the Request Form of a Command Line

(1) In Case that the Validity of a Command Line is Determined Based on an HTTP Version of the Command Line

According to the present embodiment, the request form is the version of Hyper Text Transfer Protocol (HTTP) used for writing the command line.

In order to input a command line into the search system 120 with malicious intent, a user does not manually generate a command line but may use a program for “automatically” generating a predetermined command line.

Since, generally, a command line is written according to HTTP and lower the version of the HTTP more simple and widely known the content, the program is written by using a version lower than a new version. In case that a command line is written by using HTTP of the version not generally used, the command line is highly possible to be invalid.

For example, in case that HTTP/1.1 version is generally used, the second determination system 102 selects the HTTP/1.1 version as a valid version. In case that the HTTP version of the command line is identified to be written by a version in addition to the valid version, that is, HTTP/1.1, for example, HTTP/1.0 or a version after the HTTP/1.1, the second determination system 102 may determine the command line to be invalid. A standard for determining the validity of a command line may be changed with the time passing.

(2) In Case that the Validity of a Command Line is Determined Based on Additional Information Included in the Command Line

According to the present embodiment, the request form is whether the additional information included in the command line exists. For example, the additional information is browser information if a web browser installed at the terminal or URL information of a webpage accessed by the terminal just before.

Generally, in case of accessing a server, such as a search server of the search system 120, and transmitting a command line, the web browser may include web browser information about a kind or version of the web browser in the command line and transmit the same to the server according to HTTP. Also, the web browser may include URL information of the webpage accessed by the web browser just before into the command line and transmit according to HTTP.

Accordingly, a command line not including the additional information may be automatically generated by a command line automatic generation program. Accordingly, the second determination system 102 may reflect whether the additional information is included in the command line on determining the validity of the command line.

(3) In Case that the Validity of a Command Line is Determined Based on Identification Information Included in the Command Line

The second determination system 102 allows the identification information to be included in the command line for each request content and IP address information of a terminal. Accordingly, if the input number of the command line including the identification information is computed, it may be determined how many times the command line including the identical request content is inputted from a terminal having the same IP address information.

A user generally once inputs a command line for certain request, for example, a command line for selecting a search result. Accordingly, the second determination system 102 may determine a command line including the identification information to be invalid in case that the command line having the same identification information is inputted more than twice.

(4) In Case that a Command Line is Inputted in a Certain Period After a Predetermined Event Occurs

In case that a predetermined event occurs and a command line generated according to the event is inputted in a too short time after the event occurs, the second determination system 102 may determine the command line to be invalid.

For example, in the event, the search system 120 provides a predetermined search result list to a user according to the search request of the user. The user receiving the search result list may input a command line for selecting a certain search result included in the search result list.

In this case, “a person” must pass through serial procedures of “recognizing the search result list and grasping a proper search result and selecting a search list” in order to input the command line and a certain time is necessary for performing the procedure.

Accordingly, in case that a time interval from the time point of providing the search result list to the time point that the user inputs the command line including a search result is too short, for example, 0.5 seconds, the second determination system 102 may determine the command line to be invalid.

(5) In Case that the Validity of a Command Line is Determined by using an Encode/Decode Method

In case that a user inputs a command line into a service server, such as a search server of the search system 120, the determination system 100 controls encoded information to be included in the command line.

For example, information on via which channel the command line has been inputted or information of the channel with which the command line has been inputted in association may be encoded and included.

According to each embodiment, the encoding method may be according to encoding protocol provided from the HTTP. Also, according to another embodiment of the present invention, the determination system 100 may provide a program including the encoding algorithm as a plug-in form to the terminal 110, and the terminal 110 may encode a command line according to the encoding algorithm by installing the program.

The second determination system 102 receives the encoded command line and decodes the same.

In case that the command line is not encoded or not decoded by the decoding method, the second determination system 102 determines the command line to be invalid.

2. A Procedure of Determining the Validity of a Command Line by using Log Information

(1) In Case that the Input Time Point of a Command Line has a Predetermined Rule as a Case in which a Command Line Including “Certain IP Address Information” is Inputted at Regular Time Interval

The second determination system 102 searches log information including IP address information included in the command line from log information recorded in the log database 105. According to another embodiment of the present invention, the second determination system 102 may search only log information recorded in a certain period from log information including the IP address information.

If the searched log information is first log information, the second determination system 102 extracts input time point included in the first log information and determines the command line to be invalid in case that a part or the entire of the extracted input time point information has relation according to a predetermined rule.

For example, in case that a time point of inputting the command line is “2004/04/02, 09:00:30” and input time point information included in the first log information is “2004/04/02, 08:50:30”, “2004/04/02, 08:40:30”, “2004/04/02, 08:30:30”, and “2004/04/02, 08:20:30”, it is known that a command line associated with the first log information is inputted into the search system 120 at 10 minute intervals. The regularity may include all the cases in which mathematical regularity is found, for example, a case in which the time interval is increased in arithmetic progression or geometric progression, in addition to the case in which the time interval between the input time points of inputting the command line is regular.

In case that the regularity in the time point of inputting the command line including certain IP address information is acknowledged, the command line may be a command line generated by using a program of automatically generating a command line. Accordingly, the second determination system 102 determines the command line to be invalid.

According to another embodiment of the present invention, the second determination system 102 may determine the command line to be invalid only in case that the number of input time point information according to a predetermined rule from the searched input time point information is more than a certain number.

Also, according to another embodiment of the present invention, the second determination system 102 may identify log information including input time point information according to the rule and determine all command lines associated with the identified log information to be invalid. That is, a group of command lines determined to have the regularity in the time point of the command lines inputted from a terminal having a predetermined IP address is all processed to be invalid.

(2) In Case that the Time Point of Inputting a Command Line has a Predetermined Regularity as a Case in which a Command Line Including “Certain Request Content” is Inputted at Regular Time Intervals

The second determination system 102 searches log information including the request content included in the command line from the log information recorded in the log database 105. According to another embodiment of the present invention, the second determination system 102 may search only log information recorded in a certain period from the log information including the IP address information.

If the searched log information is first log information, the second determination system 102 extracts input time point information included in the first log information and determines the command line to be invalid in case that a part or the entire of the extracted input time point information has relation according to a predetermined rule.

For example, in case that a time point of inputting the command line is “2004/04/02, 09:00:30” and input time point information included in the first log information is “2004/04/02, 08:50:30”, “2004/04/02, 08:40:30”, “2004/04/02, 08:30:30”, and “2004/04/02, 08:20:30”, it is known that a command line associated with the first log information is inputted into the search system 120 at 10 minute intervals. The regularity may include all cases in which mathematical regularity is found, for example, a case in which the time interval is increased in arithmetic progression or geometric progression, in addition to the case in which the time interval between the input time points of inputting the command line is regular.

In case that the regularity in the time point of inputting the command line including certain request content is acknowledged, the command line may be a command line generated by using a program of automatically generating a command line. Accordingly, the second determination system 102 determines the command line to be invalid.

According to another embodiment of the present invention, the second determination system 102 may determine the command line to be invalid only in case that the number of input time point information according to a predetermined rule from the searched input time point information is more than a certain number.

Also, according to another embodiment of the present invention, the second determination system 102 may identify log information including input time point information according to the rule and determine all command lines associated with the identified log information to be invalid. That is, a group of command lines determined to have the regularity in the time point of the command lines inputted from a terminal having a predetermined IP address is all processed to be invalid.

(3) In Case that an Abnormally Large Number of Command Lines are Inputted from a Terminal having a Certain IP Address for a Certain Period

The second determination system 102 computes the first number of command lines inputted from each terminal for a first period by using log information recorded in the log database 105 for the first period. A network address may be used in order to identify each terminal. That is, command lines inputted from a terminal having the same network address may be understood to be inputted from one terminal. Only, it is an exception that the network address is a network address of a proxy server or a shared unit.

The second determination system 102 computes the second number of command lines inputted from a terminal having the network address included in the command line for a second period by using log information recorded in the log database 105 for the second period.

The first period may be the same as the second period. It is preferable that the first period is longer than the second period. Also, the period of a certain period of time such as morning, afternoon, evening, midnight, and dawn is selected as the second period, thereby determining the validity of a command line by considering the pattern of inputting the command line for each period. For example, since the number of inputting command lines is notably reduced about 4 o'clock at dawn, the validity may be determined by considering this.

The second determination system 102 may determine the validity of the command line by using the first number and the second number for said each terminal.

For example, the second determination system 102 computes the average of the first number for said each terminal and compares the second number with the computed average, thereby determining the validity of the command line. In case that the second number is more than the average or a value in which a predetermined value is added to the average, the second determination system 102 may determine the command line to be invalid. Also, in case that the ratio between the average and the second number is computed and the ratio is more than a predetermined value, the second determination system 102 may determine the command line to be invalid.

Also, the second determination system 102 computes the maximum value of the first number for said each terminal or computes the dispersion value of the first number for said each terminal and compares the maximum value or the dispersion value with the second number, thereby determining the validity of the command line.

Meanwhile, in the above, the case of using the first number for said each terminal or the average of the first number is described for example. The method described above may be applied to all cases in which the first number is compared with the second number in each determination procedure described later to determine whether the first number is abnormally larger than the second number. Also, the concrete method as described above, in which the first number is compared with the second number, is no more than illustrative. The scope of the present invention is not restricted by the method and applied to all methods of determining the validity of a command line by comparing the first number having a predetermined meaning with the second number having another predetermined meaning.

(4) In Case that the Number of Inputting a Certain Command Line for a Certain Period is Abnormally Large

The second determination system 102 respectively computes the first number of command lines inputted for a first period according to a request content by using log information recorded in the log database 105 for the first period. That is, the number of command lines including the same request content is respectively computed from command lines inputted for the first period.

The second determination system 102 computes the second number of log information including a request content included in the command line by using log information recorded in the log database 105 for a second period. The second number is the number of command lines including the request content identical to the command line from the command lines inputted for the second period.

The second determination system 102 may determine the validity of the command line by using the first number and the second number for each request content. That is, the second determination system 102 compares the first number and the second number for each request content and may determine the command line to be invalid in case that the second number is determined to be abnormally larger than the first number. A concrete example of comparing the first number with the second number is as the described above.

(5) In Case that the Number of Inputting Command Lines for a Certain Request from a Terminal having a Certain IP Address for a Certain Period is Abnormally Large

The second determination system 102 computes the first number of command lines inputted for a first period for each piece of request content by using log information recorded in the log database 105 for the first period. That is, it is respectively computed how many command lines including a predetermined request content are inputted from a predetermined terminal. IP addresses may be used for determining each terminal. That is, command lines inputted from the same IP address may be understood to be inputted from one terminal.

The second determination system 102 computes the second number of command lines including the request content from the command lines inputted from the terminal having the IP address included in the command line for the second period by using log information recorded in the log database 105 for the second period.

The first period may be the same as the second period. It is preferable that the first period is longer than the second period. Also, the period of a certain period of time such as morning, afternoon, evening, midnight, and dawn is selected as the second period, thereby determining the validity of a command line by considering the pattern of inputting the command line for each period. For example, since the number of inputting command lines is notably reduced about 4 o'clock at dawn, the validity may be determined by considering this.

The second determination system 102 compares the first number and the second number for each request content and may determine the command line to be invalid in case that the second number is abnormally larger than the first number.

(6) In Case that First Information Associated with a Second Command Line does not Exist

The search system 120 receives a search query from a user, generates a search result list corresponding to the search query, and provides the generated search result list to the user. The user receiving the search result list selects a search result from the search result list, and the search system 120 provides information corresponding to the selected search result or relays a webpage associated with the search result to the user. As described above, many pieces of information are transmitted and received between the search system 120 or the determination system 100 and the terminal 110 of a user.

In the present specification, in case that the information communicated between the search system 120 or the determination system 100 and the user has the sequential relation between cause and effect, information which is a cause is defined as first information and result information generated based on the first information is defined as second information. Also, the information includes a command line.

For example, the search result list is generated based on the search query, and the search query may be defined as a first command line and the information may be defined as second information. Also, in case that the user inputs a command line for selecting the search result and the information is provided in correspondence to the selection command, the command line may be defined as a first command line and the information may be defined as second information.

The second determination system 102 generates log information corresponding to the information communicated with the terminal of the user and records in the log database 105. The log information includes the information or information on the time point of transmitting and receiving the information.

In case that a command line inputted from the terminal is determined to be a second command line by considering the request content, the second determination system 102 searches log information corresponding to first information (or a first command line) associated with the command line by referring to the log database 105. The log information corresponding to the first information associated with the command line may be searched with reference to the content of a query included in the second command line and IP address information included in the second command line.

Since a second command line is generated based on first information, if log information corresponding to the first information is not searched, the command line is not inputted according to a normal procedure. Thus, the second determination system 102 may determine the command line to be invalid.

(7) In Case that First Information Associated with a Second Command Line does not Exist—in Case that Information Included in a Command Line is used

In case that a command line is inputted according to a normal procedure, for example, a predetermined webpage is provided according to a request for providing a webpage from a user and an additional request by using information included in the webpage is inputted from the user, the additional request is premised on providing the webpage.

Accordingly, the second determination system 102 may allow history information as described above to be included in a command line in order to determine the validity of the command line. Since the history information becomes a standard for determining the validity of the command line, it is preferable that the history information is controlled to be encoded and included in the command line.

The second determination system 102 receives a first command line from a terminal of a user and provides a webpage including predetermined information to the user according to the first command line.

The user may input a second command line based on the information. For example, the first command line may be a search request including a predetermined search query, and the second command line may be a command of selecting a predetermined search result from a search result list.

In this case, the second determination system 102 allows history information to be included in the second command line. The history information includes URL information of a webpage accessed by the terminal just before (the URL information may be provided from a web browser), a first IP address of the terminal, or a second IP address of a terminal inputting the first command line. In a normal case, the second IP address of the terminal is identical to the first IP address of a terminal inputting the first command line.

According to the configuration as described above, in case that a predetermined command line is inputted, the second determination system 102 may determine whether the command line is valid by using history information included in the command line.

For example, in case that URL information corresponding to the present or previous webpage is not included in the command line, the second determination system 102 may determine the command line to be invalid.

In case that the URL information is included in the command line, and the URL is not URL of a webpage that the terminal normally accesses now or accessed before in order to input a command line, the second determination system 102 determines the command line to be invalid.

Also, in case that first IP address information of a terminal inputting a first command line is not included in a second command line capable of being generated premised on inputting of the first command line, the second determination system 102 determines the command line to be invalid.

Also, the second determination system 102 compares first IP address information included in the second command line with second IP address information and determines the second command line to be invalid in case that the first IP address information is not identical to the second IP address information.

(8) In Case that the Number of a Certain Query is Abnormally Large in a Certain Network Group for a Certain Period

The second determination system 102 identifies the validity of the command line by using the identified network group information.

The second determination system 102 respectively computes the first number of command lines inputted from each terminal for a first period for each piece of request content by using log information recorded in the log database 105. The second determination system 102 may determine a command line inputted from a terminal having the same IP address to be inputted from one terminal. Only, it is an except that the network address is an IP address of a proxy server or a shared unit.

The second determination system 102 computes the second number of a command line including the request content and associated with the same network group information for a second period by using log information recorded in the log database 105.

The second determination system 102 compares the first number with the second number and may determine the command line to be invalid in case that the second number is abnormally larger than the first number.

Accordingly, according to the present embodiment, it may be sensed that a predetermined command line is inputted with malicious intent by using a plurality of terminals accessing an identical network group such as an identical network class.

(9) In Case that Command Lines Whose Identification Information is the Same is Repeatedly Inputted

In the present embodiment, in case that a command line requesting predetermined information is received from a terminal of a user, the second determination system 102 controls the information or identification information associated with the IP address of the terminal to be included in the command line.

Also, the second determination system 102 determines the input number of command lines including the identification information by referring to identification information included in the command line. In case that it is determined that a plurality of command lines including the identification information is inputted, the second determination system 102 determines the command line to be invalid.

According to the configuration described above, the second determination system 102 may determine whether a user of the same terminal repeatedly requests the same information, and regard a command line unnecessarily repeatedly requesting the information provided once as a command line inputted with malicious intent.

In the above, the procedure of determining the validity of a command line based on a request format (step 602) performed at the second determination system 102 with respect to a command line filtered at the first determination system 102 and the procedure of determining the validity of a command line by using log information (step 605) are concretely described. The second determination system 102 may select at least one of the determination methods as described above and may determine the validity of the command line by synthetically examining the determination result according to each determination method. Also, the second determination system 102 adds a weight to each determination result and computes the entire determination result, thereby determining the validity of the command line.

According to another embodiment of the present invention, the block database 104 of the first determination system 101 may be updated by the validity determination result at the second determination system 102.

That is, the determination system 100 identifies IP address information with respect to a terminal inputting the command line in case that the command line is determined to be invalid through the 2. (1) to (3) and (5).

The determination system 100 computes the first number of command lines including the IP address information and inputted for a certain period. Also, the determination system 100 computes the second number of command lines determined to be invalid by the second determination system 102 from the command lines.

The determination system 100 may determine whether the terminal “inputs a plurality of command lines with malicious intent abnormally” by using the first number and the second number.

That is, in case that a plurality of command lines from inputted command lines is determined to be invalid, a user of the terminal may be determined to input a command line repeatedly with malicious intent. Accordingly, since a command line inputted from the terminal hereafter is highly possible to be invalid, the determination system 100 determines IP address information with respect to the terminal to be block IP address information and records in the block database 104, thereby updating the block database 104. The determination system 100 determines a command line inputted from the terminal to be invalid without determining the validity by using the determination method.

Various methods as described above, such as, the method of computing the ratio of the first number to the second number and determining whether the ratio exceeds a predetermined value, may be used to determine whether the second number is comparatively larger than the first number. The scope of the present invention is not restricted by the type of the methods.

Also, according to another embodiment of the present invention, the determination system 100 may record IP address information that is highly possible to be determined as block IP information in case that an invalid command line is inputted continuously hereafter, although the IP address information is not much to be determined as block IP information, as a result of determination by using the first number and the second number, in an invalid suspect IP address database (not illustrated). Through this, the determination system 100 may intensively manage the IP address information. Also, according to another embodiment of the present invention, a plurality of invalid suspect IP address databases may exist. Thus, two and more determination procedures may be performed to determine a predetermined IP address as a block IP address.

According to the configuration as described above, in case that it is difficult to determine whether IP address information of a terminal inputting the command line is block IP address information only with log information with respect to command lines inputted so far, the IP address information is determined to be invalid suspect IP address information, and hereafter, a command line including the IP address information is further observed, thereby determining whether to determine the IP address information to be block IP address information. Thus, it is possible to more accurately determine whether a predetermined command line is invalid.

Also, according to another embodiment of the present invention, a manager of the determination system 100 may update the permit database 103 or the block database 104 according to collected information, such as, information recorded in the log database 105.

Also, according to another embodiment of the present invention, the determination system 100 may periodically update the permit database 103 or the block database 104. For example, the determination system 100 deletes a permit keyword in case that the permit keyword recorded in the permit database 103 according to a predetermined criterion does not act as a permit keyword any more, thereby updating the permit database 103.

Meanwhile, the determination system 100 may generate a predetermined effect with respect to a command line that is determined to be invalid according to the configuration described above. For example, in case that the command line is a request for selecting a search result from a search result list provided by the search system 120, the search system 120 may transmit information associated with the selected search result to the terminal irrespective of whether the command line is invalid. Only, in case that the command line is used as a standard to charge an advertiser offering advertising in association with the search result, or a standard to determine the preference of a user selecting the search result, it is preferable that the command line determined to be invalid may not be used as the standard.

Also, the embodiments of the present invention include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts.

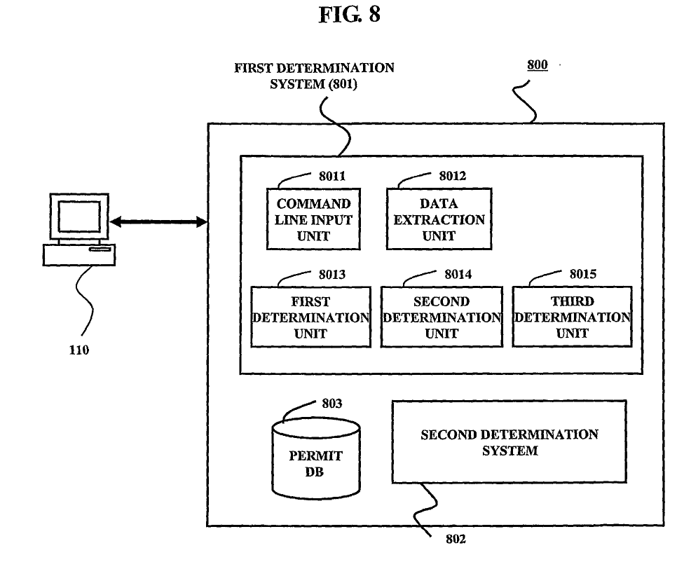

Hereinafter, the determination system 100 determining the validity of a command line according to another embodiment of the present invention will be described. FIG. 8 is a block diagram illustrating internal configuration of the determination system 100 or 800. The determination system 800 includes a first determination system 801, a second determination system 802, and a permit database 803.

Also, the first determination system 801 includes a command line input unit 8011, a data extraction unit 8012, a first determination unit 8013, a second determination unit 8014, and a third determination unit 8015.

The permit database 803 includes information on a permit network address and at least one block keyword associated with the permit network address. An example of data recorded in the permit database 803 is as illustrated in FIG. 3.

The command line input unit 8011 receives a command line including a request content from the terminal 110 of a user. The data extraction unit 8012 extracts IP address information or the request content included in the command line.

The first determination unit 8013 determines whether the extracted IP address information is permit IP address information by referring to the permit database 803.

The second determination unit 8014 determines whether the request content has relation with the at least one block keyword associated with the permit IP address information by referring to the permit database 803, in case that it is determined that the extracted IP address information is permit IP address information.

The third determination unit 8015 determines the command line to be valid in case that the request content has no relation with the block keyword.

Meanwhile, the second determination system 802 performs validity determination with respect to the command line according to a predetermined determination method, in case that it is determined that the extracted request content has relation with the block keyword.

The concrete configuration of determining the validity of a command line according to a predetermined determination method has been described in the aforementioned embodiments. Thus, description related thereto will be omitted in the present embodiment.

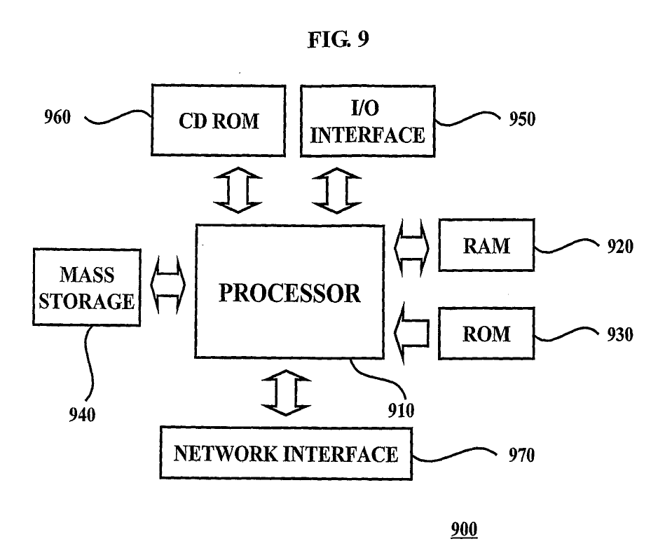

FIG. 9 is an internal block diagram of a general-purpose computer which can be adopted in implementing the command line validity determination method according to the present invention.

A computer apparatus 900 includes at least one processor 910 connected to a main memory device including a RAM (Random Access Memory) 920 and a ROM (Read Only Memory) 930. The processor 910 is also called as a central processing unit CPU. As well-known to the field of the art, the ROM 930 unidirectionally transmits data and instructions to the CPU, and the RAM 920 is generally used for bidirectionally transmitting data and instructions. The RAM 920 and the ROM 930 may include a certain proper form of a computer readable recording medium. A mass storage device 940 is bidirectionally connected to the processor 910 to provide additional data storage capacity and may be one of the computer readable recording medium. The mass storage device 940 is used for storing programs and data and is an auxiliary memory. A particular mass storage device such as a CD ROM 960 may be used. The processor 910 is connected to at least one input/output interface 950 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 910 may be connected to a wired or wireless communication network via a network interface 970. The procedure of the described method can be performed via the network connection. The described devices and tools are well-known to those skilled in the art of computer hardware and software.

The described hardware devices may be formed to be operated by at least one software module in order to perform the operations of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

According to the present invention, there are provided method and system for determining the validity of a command line, which can simply determine the validity of a command line inputted from a user in accordance with a predetermined rule and perform an additional validity determination by a selected determination method only in case that it is impossible to determine the validity of the command line in accordance with the rule.

Also, according to the present invention, there are provided method and system for determining the validity of a command line, which divides a command line validity determination process into two parts, a first process of determining whether a command line corresponds to a predetermined rule and a second process of determining the validity of a command line not corresponding to the rule in accordance with a predetermined determination method, and can reduce load of a system performing a command line validity determination and enhance the speed thereof by terminating a command line validity determination process by using the first process only, with respect to a command line of which validity can be determined simply and fast.

Also, according to the present invention, there are provided method and system for determining the validity of a command line, which can basically prevent a command line that is received from a bad user habitually inputting a command line determined to be invalid from be determined to be valid. That is, in a method of filtering a predetermined command line by using block network address information or block network group information, even in case that a user who has inputted a command line with malicious intent by using a predetermined terminal tries to hide his/her malicious intent by using another method, thereby inputting an illegal command line, it is possible to determine all the command lines inputted from a terminal having a block network address (or having a network address included in a block network group) to be invalid, thereby invalidating all the command lines inputted from the terminal with malicious intent.

Also, according to the present invention, there are provided method and system for determining the validity of a command line, which determines a command line inputted from a network address or a network group that is reliable and well-known, such as a command line inputted from a network address of a terminal of a manager or a developer, and a command line inputted from a network address of a terminal of government and public offices or a large company, to be valid, thereby omitting an additional validity determination process.

Also, according to the present invention, there are provided method and system for determining the validity of a command line, which can more accurately determine the validity of a command line by not omitting a validity determination process with respect to a command line including a request content has the least possibility to be inputted from public and government offices, although the command line is inputted from the public and government offices and the large company.

1-6. (canceled)

7. A computer-implemented method for determining the validity of a command line in a command line validity determination system, comprising the steps of:
maintaining a permit database, the permit database including at least one permit network address information;
receiving a command line from a user terminal;
extracting network address information included in the command line; and
determining a validity of the command line based, at least in part, upon network address included in the command line and the permitted network address information.

8. The method of claim 7, wherein:
the permit database further includes permitted network group information including at least one permitted network group information; and
the method further comprises the steps of:
identifying network group information including the extracted network address information by using the same;
determining whether permitted network group information corresponding to the identified network group information exists by referring to the permit database; and
performing validity determination with respect to the command line in accordance with a predetermined determination method, in case that it is determined that permitted network group information corresponding to the identified network group information is absent.

9. The method of claim 7, further comprising the steps of:
maintaining a block database including at least one blocked network address information;
receiving a command line from a user terminal;
extracting network address information included in the command line;
determining whether blocked network address information corresponding to the extracted network address information exists by referring to the block database; and
performing validity determination with respect to the command line in accordance with a predetermined determination method in case that it is determined that block network address information corresponding to the extracted network address information is absent.

10. The method of claim 9, wherein the blocked network address information is network address information of a terminal of a manager or a developer of the command line validity determination system, or network address information of a terminal of a predetermined advertiser.

11. The method of claim 7, further comprising the steps of:
computing the first number of first command lines that are inputted for a predetermined period and include the extracted network address information in case that blocked network address information corresponding to the extracted network address information is absent;
computing the second number of second command lines that are determined to be invalid by the determination method, among the first command lines; and
recording the extracted network address information in the block database in case that the ratio of the first number and the second number exceeds a predetermined value.

12. The method of claim 7, further comprising the steps of:
computing the second number of second command lines that are determined to be invalid by the determination method, among the first command lines that are inputted for a predetermined period and include the extracted network address information, in case that blocked network address information corresponding to the extracted network address information is absent; and
recording the extracted network address information in the block database in case that the second number exceeds a predetermined value.

13. The method of claim 7, wherein:
the block database further includes blocked network group information including at least one blocked network group information;
identifying network group information in which the extracted network address information is included, by using the extracted network address information;
determining whether blocked network group information corresponding to the identified network group information exists by referring to the block database; and
performing validity determination with respect to the command line in accordance with a predetermined determination method, in case that it is determined that blocked network information corresponding to the identified network group information is absent.

14. A method for determining the validity of a command line, comprising the steps of:
maintaining a permit database, the permit database including at least one predetermined keyword associated with permitted network group information;
receiving a command line including a request content from a user terminal;
identifying network group information associated with the network address information;
determining a validity of the command line based, at least in part, upon the identified network group information and is permitted network group information by referring to the permit database; and
determining a validity of the command line based, at least in part, upon the request content included in the command line and the predetermined keyword included in the permit database, in case that it is determined that the identified network group information is permit network group information.

15-16. (canceled)

17. A storage medium encoded with machine-readable computer program for implementing the method recited in claim 7.

18. A system for determining the validity of a command line, comprising:
a permit database, the permit database including information on a permitted network address and at least one blocked keyword associated with the permitted network address;
a first determination system, the first determination system including a command line input unit, a data extraction unit, a first determination unit, a second determination unit, and a third determination unit, the command line input unit receiving a command line including a request content from a terminal of a user, the data extraction unit extracting network address information or the request content included in the command line, the first determination unit determining whether the extracted network address information is permitted network address information by referring to the permit database, the second determination unit determining whether the request content has relation with the at least one blocked keyword associated with the permitted network address information by referring to the permit database, in case that it is determined that the extracted network address information is permitted network address information, and the third determination unit determining the command line to be valid in case that it is determined that the extracted request content has no relation with the blocked keyword; and
a second determination system, the second determination system performing validity determination with respect to the command line in accordance with a predetermined determination method, in case that it is determined that the extracted request content has relation with the blocked keyword.

19. A computer-implemented method for determining the validity of a command line, the method comprising the steps of:
maintaining a permit database, the permit database including information on at least one permitted network address and at least one predetermined keyword associated with each of the permitted network address;
receiving a command line from a user terminal; and
determining a validity of the command line based, at least in part, upon the request content included in the command line and the predetermined keyword included in the permit database.

20. The method of claim 19, further comprising the step of:
determining a validity of the command line in accordance with a predetermined determination method, in case that the command line is determined to be invalid based upon the request content included in the command line and the predetermined keyword included in the permit database.

21. The method of claim 20, wherein the step of determining a validity of the command line in accordance with a predetermined determination method comprises the steps of:
interpreting a request form of the command line;
generating log information associated with the command line, in which the log information includes at least one selected from the group consisting of network address information included in the command line, the request content included therein, and input time point information about the input time point of the command line;
recording the log information in a log database; and
determining the validity of the command line by using the request form or the log information.

22. The method of claim 21, wherein the step of determining the validity of the command line by using the log information comprises the steps of:
searching log information recorded in the log database for log information including the network address information;
extracting input time point information included in the searched log information; and
determining the command line to be invalid in case that the entire or a part of the extracted input time point information has relation according to a predetermined rule.

23. The method of claim 19, further comprising the step of:
determining a validity of the command line based, at least in part, upon the permitted network address information included in the permit database.

24. The method of claim 19, wherein the predetermined keyword is a blocked keyword.

25. The method of claim 24, further comprising the step of:
determining a validity of the command line based, at least in part, upon the request content included in the command line and a permitted keyword, and wherein the permit database includes at least one permitted keyword associated with the permit network address.

26. The method of claim 19, wherein the predetermined keyword is a permitted keyword.

27. The method of claim 26, further comprising the step of:
determining a validity of the command line based, at least in part, upon the request content included in the command line and a blocked keyword, and wherein the permit database includes at least one blocked keyword associated with the permit network address.

28. The method of claim 26, further comprising the steps of:
computing the input number of the command line associated with the permitted keyword for each period; and
updating the permit database by using the input number for each period.

29. The method of claim 14, further comprising the step of:
determining a validity of the command line in accordance with a predetermined determination method, in case that the command line is determined to be invalid based upon the request content included in the command line and the predetermined keyword included in the permit database.

30. The method of claim 29, wherein the step of determining a validity of the command line in accordance with a predetermined determination method comprises the steps of:
interpreting a request form of the command line;
generating log information associated with the command line, in which the log information includes at least one selected from the group consisting of network address information included in the command line, the request content included therein, and input time point information about the input time point of the command line;
recording the log information in a log database; and
determining the validity of the command line by using the request form or the log information.

31. The method of claim 30, wherein the step of determining the validity of the command line by using the log information comprises the steps of:
searching log information recorded in the log database for log information including the network address information;
extracting input time point information included in the searched log information; and
determining the command line to be invalid in case that the entire or a part of the extracted input time point information has relation according to a predetermined rule.

32. A storage medium encoded with machine-readable computer program for implementing the method recited in claim 14.

33. A storage medium encoded with machine-readable computer program for implementing the method recited in claim 19.
